(19) United States
(12) Patent Application Publication
(10) Pub. No.: US 2015/0084548 A1
(43) Pub. Date: Mar. 26, 2015

(54) CIRCULAR ACCELERATOR

(71) Applicant: HITACHI, LTD., Tokyo (JP)

(72) Inventors: Shigemitsu HARA, Tokyo (JP); Fumiaki NODA, Tokyo (JP); Takamichi AOKI, Tokyo (JP)

(21) Appl. No.: 14/457,146

(22) Filed: Aug. 12, 2014

(30) Foreign Application Priority Data
Sep. 26, 2013 (JP) 2013-199133

(51) Int. Cl. H05H 7/10; H05H 7/04; H05H 13/00; H05H 7/02

(52) U.S. Cl. CPC H05H 7/10; H05H 7/02; H05H 7/04; H05H 13/00; H05H 2007/025; H05H 2007/045
USPC 315/501

(57) ABSTRACT

A circular accelerator of the present invention includes an electrode that applies a high frequency electric field for accelerating a charged particle beam, an electromagnetic device that bends the charged particle beam, and a direct current (or DC) power supply device that applies a direct current (or DC) electric field to the previous described electrode.

### BACKGROUND

The present invention relates to a circular accelerator that accelerates a charged particle beam to a high energy by way of a high frequency electric field while circulating the charged particle beam in a magnetic field and extracting the accelerated charged particle beam externally.

Circular accelerator types include cyclotrons and synchrocyclotrons, etc. In cyclotrons, a charged particle beam emitted for example from an ion source operating in a high vacuum is accelerated with circular motion in a magnetic field. In order to accelerate the charged particle beam, the cyclotron inputs the charged particle beam from the ion source in a circular orbit on a plane that is perpendicular to the magnetic field, applies a high frequency alternating current voltage to a so-called dee electrode mounted along that circular orbit, accelerates the passing charged particle beam, and increases the energy of that charged particle beam.

A synchrocyclotron disclosed in Japanese Unexamined Patent Application Publication (Translation of PCT Application) No. 2008-507826 has the main features of firstly frequency modulating the acceleration frequency from a high frequency voltage applicator electrode at approximately 1 kHz operating cycles during beam acceleration; secondly focusing the beam in the longitudinal direction based on the principle of high frequency acceleration phase stability, and thirdly focusing the beam vertical direction in a weak focus magnetic field. In the device disclosed in Japanese Unexamined Patent Application Publication (Translation of PCT Application) No. 2008-507826, the frequency modulation of resonance frequency at 1 KHz level is extremely difficult from a technical standpoint.

In a cyclotron disclosed in Japanese Unexamined Patent Application Publication (Translation of PCT Application) No. Hei5 (1993)-501632, a charged particle beam extracted from an ion source is gradually accelerated after each passage by way of an acceleration electrode while circulated by a bending magnetic field. The diameter of the circular orbit of the charged particle beam gradually becomes larger as the charged particle beam is accelerated and its energy increases, and achieves a spiral orbit and after the accelerated charged particle beam reaches the maximum energy level, is extracted by an extraction deflector and transported outside the accelerator. The operation thus far is the same as the synchrocyclotron.

In order for a cyclotron to stably accelerate the charged particle beam, a specified high frequency acceleration electric field must first of all be applied in the beam longitudinal direction at a timing that matches the passage of the charged particle beam; secondly a specified focusing force must be applied in the beam vertical direction, moreover thirdly there is no focusing force in the beam longitudinal direction.

The cyclotron disclosed in Japanese Unexamined Patent Application Publication (Translation of PCT Application) No. Hei5 (1993)-501632 differs from the synchrocyclotron in that there is no need to modulate the frequency of the high frequency acceleration electric field since a magnetic field distribution for the bending magnet is generated to prevent the changes occurring along with acceleration of the charged particle beam circulating frequency. This magnetic field is called an isochronous magnetic field. The isochronous magnetic field has no focusing force acting on the longitudinal direction of the beam, so has accuracy as high as 1×10⁻⁶ for shaping the magnetic field from the magnet and moreover increases the acceleration voltage with a structure of several hundred turns for extracting the beam. Providing an isochronous magnetic field requires a magnetic field distribution that becomes intense in the direction having a larger radius, causing a large defocusing force to occur in the vertical direction. To obtain a focusing force in vertical direction capable of cancelling out this defocusing force, the bending magnet is a sector concentration cyclotron or AVF cyclotron structure having alternately repeating large valley gaps of magnetic pole and small hill gaps of magnetic pole along the circulation direction of the charged particle beam, and the magnetic pole is a spiral shape.

Japanese Patent Application No. 2011-244298 discloses an idea for varying the energy of the extraction beam by changing the bending magnetic field so that the amount of change in the bending magnet between 0.7% and 24.7%. However, changing the intensity of the magnetic field requires time, and instantaneously changing the energy of the extraction beam is impossible.

### SUMMARY

Changing the energy of the extraction beam in synchrocyclotrons and cyclotrons of the related art requires changing the intensity of the magnetic field or changing the frequency of the high frequency acceleration electric field. However, making a large change in the magnetic field intensity also causes a large change in the spatial distribution in the isochronous magnetic field, causing the problem that a long time is required for adjusting this isochronous magnetic field. Also, making a large change in the acceleration frequency requires making a large change in the resonance frequency of RF acceleration cavity so the problem occurs that a long time is needed to adjust this resonance frequency. Due to the aforementioned reasons, making a large instantaneous change in the energy of the synchrocyclotron and cyclotron extraction beam is impossible.

In presently utilized synchrocyclotrons and cyclotrons, the energy from the accelerator cannot be changed, so after extracting a beam at a specified energy, the degrader causes an energy loss that changes the energy level; however, this method has the problem that a larger device must be fabricated along with the beam performance gradually deteriorates.

According to one aspect of the present invention and in view of the aforementioned problems, the present invention has the object of providing a circular accelerator that allows freely varying the energy of the extraction beam while maintaining the acceleration frequency and bending magnetic field of the charged particle beam.

According to another aspect of the present invention to resolve the aforementioned problems, the circular accelerator of the present invention includes an electrode that applies a high frequency electric field for accelerating a charged particle beam, an electromagnetic device that bends the charged particle beam, and a direct current (DC) power supply device that applies a direct current electric field to the electrode.

According to another aspect of the present invention, the circular accelerator is capable of changing the energy of the charged particle beam extracted from the circular accelerator, and preventing deterioration in beam performance due to the emittance growth and so on that occurs along with the energy loss in the beam due to the degrader, and further requires no degrader of the related art in order to change the energy. Furthermore, the overall accelerator system can be achieved in a compact size and a lower cost because no degrader is required.

### BRIEF DESCRIPTION OF THE DRAWINGS

FIG. 1 is an illustrative diagram showing the overall structure of the energy-variable type circular accelerator according to the first embodiment of the present invention;

FIG. 2 is an illustrative diagram showing a perpendicular cross section of the overall structure of the energy-variable type circular accelerator according to the first embodiment of the present invention;

FIG. 3 is a drawing showing an overview of the beam drift orbit of the energy-variable type circular accelerator according to the first embodiment of the present invention;

FIG. 4 is a drawing showing the relation between the radius re applied DC voltage, the DC voltage Vdc, and the extracted beam energy when the present invention is applied to a cyclotron device for PET pharmaceutical manufacture;

FIG. 5 is a concept drawing showing the overall structure of the energy-variable type circular accelerator according to the second embodiment of the present invention;

FIG. 6 is an illustrative diagram showing the overall structure of the energy-variable type circular accelerator according to the third embodiment of the present invention;

FIG. 7 is an illustrative diagram showing the overall structure of the low-loss beam extraction system of the circulator accelerator according to the fourth embodiment of the present invention; and

FIG. 8 is a drawing showing the overall structure of the traditional circulator accelerator of the related art.

### DETAILED DESCRIPTION

The present invention can apply in general to all circular beam accelerator devices however the description given here is for an energy-variable type circular accelerator and an extracted beam energy changing method.

### First Embodiment

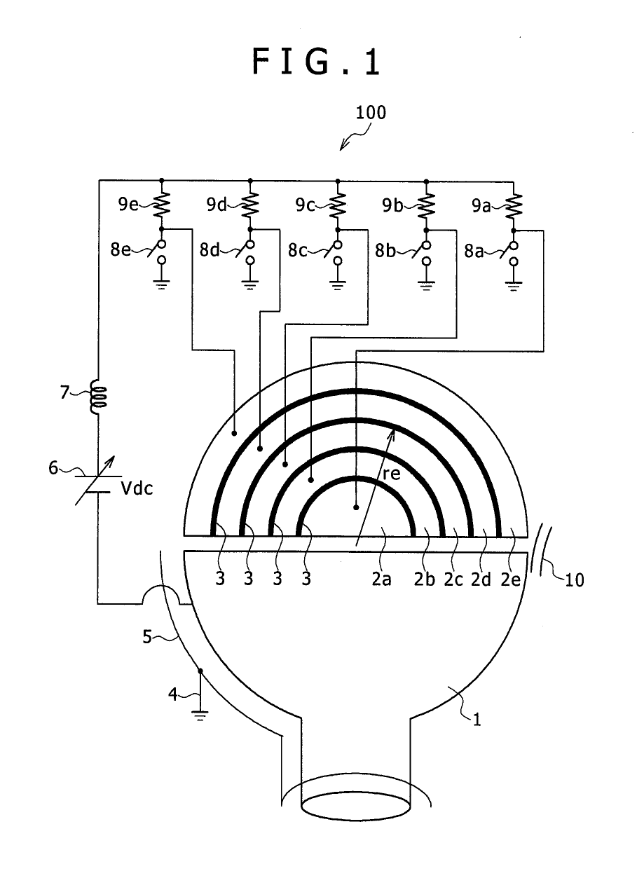

A preferred embodiment of the circular accelerator of the present invention is described while referring to FIG. 1. FIG. 1 is an illustrative diagram showing the overall structure of the perpendicular cross section of the circular accelerator 100 of the present embodiment. The extracted beam energy change in the charged particle beam by the circular accelerator 100 of the present embodiment is described next.

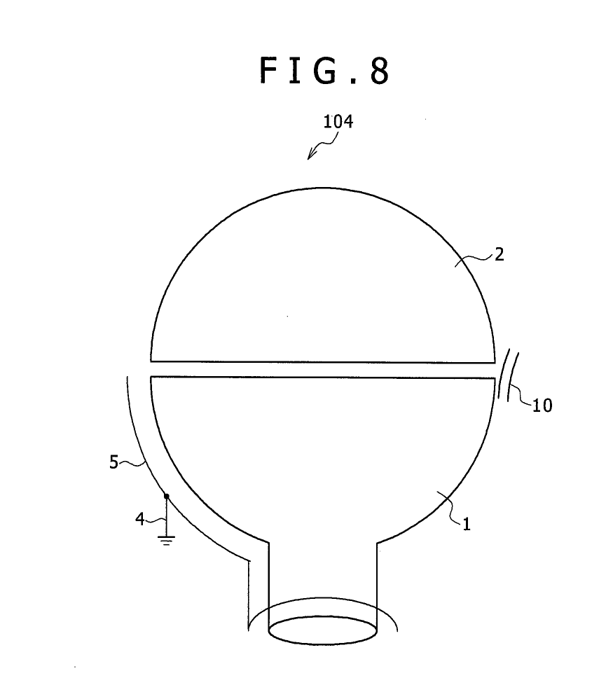

The beam energy-variable type circular accelerator 100 of the present embodiment contains a dee electrode 1, the dummy dee electrodes 2a, 2b, 2c, 2d, 2e insulated and divided in a concentric circle shape by an insulator material 3, a DC power supply 6, an inductance 7 for maintaining a high impedance cavity resonator, multiple switches 8, multiple resistors 9, and an electrostatic deflector electrode 10. The dummy electrodes are insulated and divided in the structure utilized in the present embodiment; however, the present invention is not limited to five separate insulations and for example a structure with multiple separate insulations may be utilized. The dee electrode as referred to here is defined as the high-voltage side electrode among the two electrodes for accelerating the particles by generating a high frequency electric field between the electrodes mounted along the circular orbit. The dummy dee electrode is defined as the ground voltage side electrode among the two electrodes for accelerating the particles. The charged particle beam generated in the ion source (not shown in drawing) is injected to the center section of the circular accelerator 100, and is sequentially accelerated by a high-frequency acceleration electric field between the dummy dee electrodes 2a, 2b, 2c, 2d, 2e insulated and divided in a concentric circle shape by the insulator material 3, and the dee electrode 1 to which high-frequency (RF) electric power is transmitted along the coaxial mode from the quarter-wave cavity resonator. A magnetic field is applied across the paper direction in the region occupied by the dee electrode 1 and the dummy dee electrodes 2a through 2e so that the beam orbit along which the charged particle beam passes acquires a spiral shape due to bending by the magnetic field; and the charged particle beam finally extracted by the electrostatic deflector electrode 10 mounted on the outer side of the dummy dee electrode 2e. The circular accelerator 100 of the present embodiment differs from the traditional circular accelerator of the related art shown in FIG. 8 in containing a DC power supply 6; the dummy dee electrode 2 is divided into multiple electrodes in a concentric circle shape and each of the divided dummy dee electrodes 2a, 2b, 2c, 2d, 2e are insulated by an insulator material 3; and a switch unit 8 provided for selecting whether or not to apply a DC voltage from the DC power supply 6 to each of the dummy dee electrodes 2a, 2b, 2c, 2d, 2e.

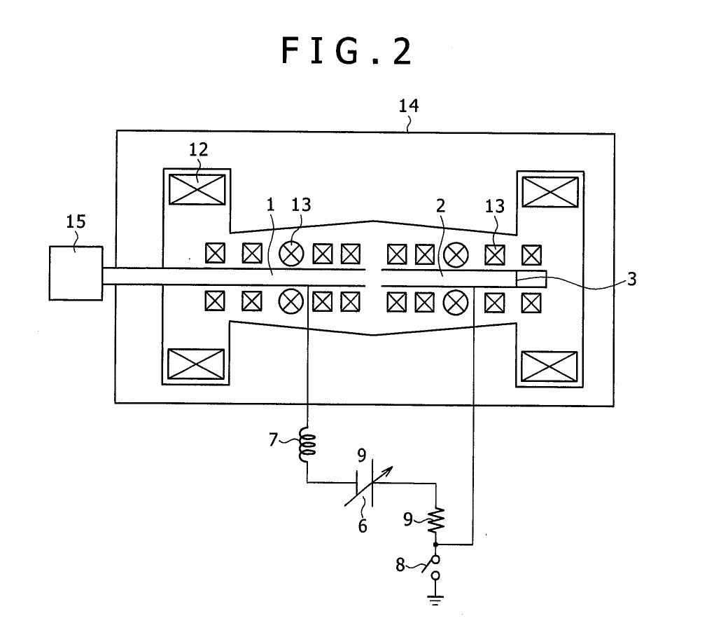

FIG. 2 shows a perpendicular cross section of the overall structure of the beam energy-variable type circular accelerator 100 according to the first embodiment. As shown in FIG. 2, the beam energy-variable type circular accelerator 100 of the present embodiment in addition to the structural device in FIG. 1 also contains a main magnetic field coil 12 for bending the charged particle beam, an auxiliary magnetic field coil 13 for adjusting the magnetic field, an electromagnet core 14, and an RF power supply 15.

The method employed by the circular accelerator 100 for changing the energy of the charged particle beam and for operation is described next. A DC power supply 6 is connected between the dee electrode 1 for transmitting the high frequency field and the dummy dee electrodes 2a through 2e, and the DC voltage generated by the DC power supply 6 is connected to each of the dummy dee electrodes 2a through 2e by way of the multiple resistors 9 branching in parallel. The switch units 8a, 8b, 8c, 8d, 8e are usually closed towards the ground voltage side, and each of the dummy dee electrodes 2a through 2e is at ground voltage. The resistors 9a, 9b, 9c, 9d, 9e are used for limiting the current from the DC power supply 6, and the inductance 7 is a device for preventing a drop in the shunt impedance of the RF cavity and for maintaining a high shunt impedance. The dummy dee electrode 2a is connected between the switch 8a and the resistor 9a; the dummy dee electrode 2b is connected between the switch 8b and the resistor 9b; and the dummy dee electrode 2c is connected between the switch 8c and the resistor 9c; the dummy dee electrode 2d is connected between the switch 8d and the resistor 9d; and the dummy dee electrode 2e is connected between the switch 8e and the resistor 9e. Opening the switch units 8a through 8e connected to each of the dummy dee electrodes 2a through 2e applies a DC voltage Vdc from the DC power supply 6. In other words, on and off control can be achieved by applying a DC voltage Vdc to each of the dummy dee electrodes 2a through 2e by separately controlling the opening and closing of each of the switch units 8a through 8e. A DC electric field E is applied by way of the DC voltage Vdc between the dee electrode 1 and the dummy dee electrodes 2a through 2e so that an E×B drift is generated towards the perpendicular angle formed by the bending magnetic field B and the DC electric field E along the orbit of the charged particle beam. A certain DC voltage Vdc is applied to a radius re of any of the dummy dee electrodes 2a through 2e, to adjust the generated E×B drift and change the energy of the extraction beam.

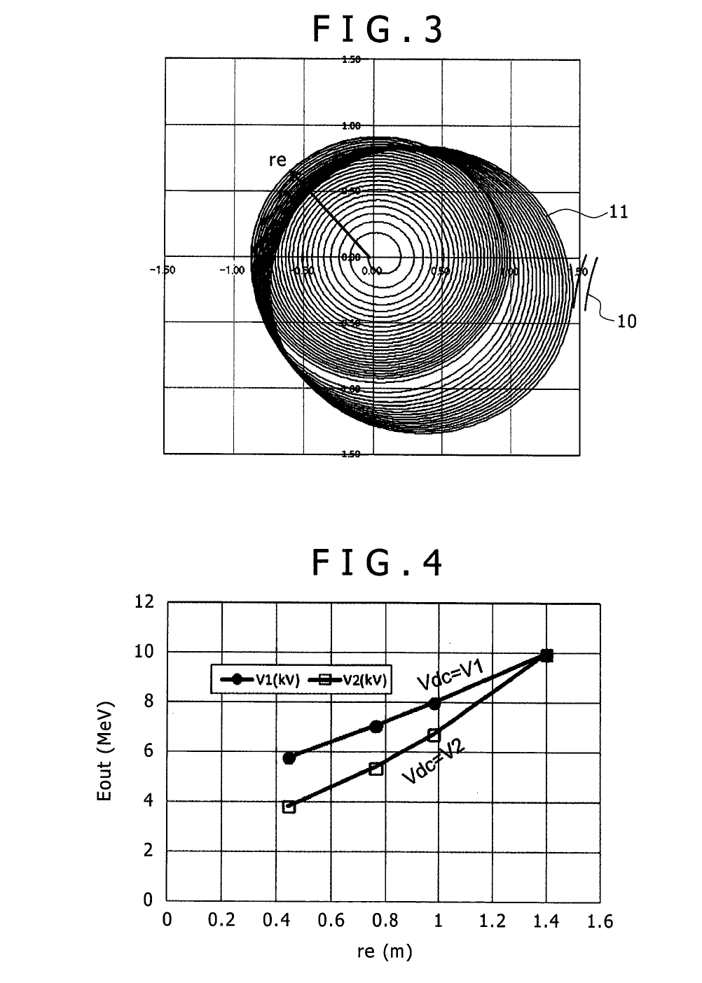

Here, taking a proton cyclotron for PET pharmaceutical manufacture as one example of a circular accelerator, the specifications required for the system are approximately an acceleration frequency to 50 MHz, a beam current peak value to 1.0 mA, an input energy 30 keV, and an extraction energy of 10 MeV. The high frequency (RF) acceleration voltage required in this case is up to 100 kV, and the beam bending magnetic field is up to 0.33 T. FIG. 3 shows one example of the beam orbit in the present embodiment, when the charged particle beam is accelerated without applying a DC voltage inside the radius re of the dummy dee electrode, and when the charged particle beam is accelerated while applying a DC voltage to the dummy dee electrode from outside the radius re. In FIG. 3, an E×B drift is generated along the spiral-shaped orbit to the radius re by the beam bending magnetic field B and the electric field E from the DC voltage Vdc at the outer side from re, the beam orbit 11 drift from the center to the outer side, and the charged particle beam is extracted by the electrostatic deflector electrode 10. FIG. 4 shows one example of the relation of the DC voltage Vdc and the radius re for starting to apply a DC voltage for the beam extraction energy. As shown in FIG. 4, the beam extraction energy can be freely changed by adjusting the DC voltage Vdc and the radius re where application of the DC voltage starts. If insulation materials such as Mylar®, polycarbonate, and Kapton® are utilized for insulating the DC voltage from the DC power supply, the break down electric field will have a solid insulation performance (or insulation performance for solids) of 100 kV per millimeter or higher and so the design can provide a sufficient insulated structure.

The circular accelerator 100 of the present embodiment is capable of changing the extraction beam energy, requires no degrader of the related art for changing the energy, and can therefore prevent degradation in beam performance due to the emittance growth and so on generated accompanying the energy loss in the beam due to the degrader. Moreover, the overall accelerator system can be achieved in a compact size and a lower cost because no degrader is required.

The present embodiment is capable of changing and adjusting the energy of the extraction beam from the circular accelerator 100 by adjusting the DC voltage and concentric radius with the multiple insulated and divided dummy dee electrodes 2 to which the DC voltage is applied. No changes are made to the magnetic field and the acceleration frequency so that the overall circular accelerator system including an energy change device for the extraction beam is capable of high performance, a compact size, and a lower cost, and also capable of extracting the beam with high efficiency and minimal beam loss, which contributes to even higher performance.

### Second Embodiment

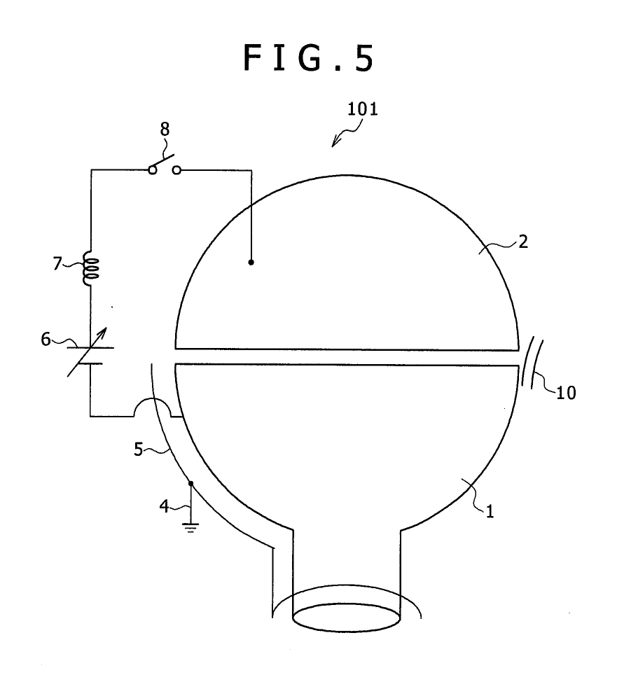

The circular accelerator of the second embodiment of the present invention is described next while referring to FIG. 5. FIG. 5 is a concept drawing showing the overall structure of the vertical cross section of the circular accelerator 101 of the present embodiment.

The circular accelerator 101 of the present embodiment is a structure that applies a DC voltage Vdc from the DC power supply 6 between the dee electrode 1 and the dummy dee electrode 2, to in this way generate an E×B drift by way of an electric field E and bend magnetic field B, to change the extracted beam energy and extract the charged particle beam the same as the circular accelerator 100 of the first embodiment. In the circular accelerator 100 of the first embodiment, the multiple dummy dee electrodes are each formed concentrically as multiple separate insulation structures. However, in the circular accelerator 101 of the present embodiment, the dummy dee electrode 2 is not separate insulation structures, and is a structure that is one dummy dee electrode. Comparing the circular accelerator 101 of the present embodiment with the circular accelerator 100 having dummy dee electrodes that are insulated and divided in a concentric state as in the first embodiment, shows that the circular accelerator 101 of the present embodiment utilizes only one dummy dee electrode structure so that the manufacturing cost can be reduced and consecutive changes can be made to the energy. However, a DC electric field is applied across the entire region around the dee electrodes so that an E×B drift is generated at the entire region, and therefore the case might occur where the particles are not capable of normally accelerating to the target energy due to disruption of the isochronism when drift occurs in the beam orbit. So in order to compensate the isochronous magnetic field, installing additional equipment such as a trim coil might become necessary.

The circular accelerator 101 of the present embodiment is capable of changing the extraction beam energy, requires no degrader of the related art for changing the energy, and can therefore prevent degradation in beam performance due to the emittance growth and so on generated accompanying the energy loss in the beam due to the degrader. Moreover, the overall accelerator system can be achieved a compact size and a lower cost because no degrader is required.

The present embodiment is capable of changing and adjusting the energy of the extraction beam from the circular accelerator 101 by adjusting the DC voltage and concentric radius with the dummy dee electrode 2 to which the DC voltage is applied. No changes are made to the magnetic field and the acceleration frequency so that the overall circular accelerator system including an energy change device for the extraction beam is capable of high performance, a compact size, and a lower cost, and also capable of extracting the beam with high efficiency and minimal beam loss, which contributes to even higher performance.

### Third Embodiment

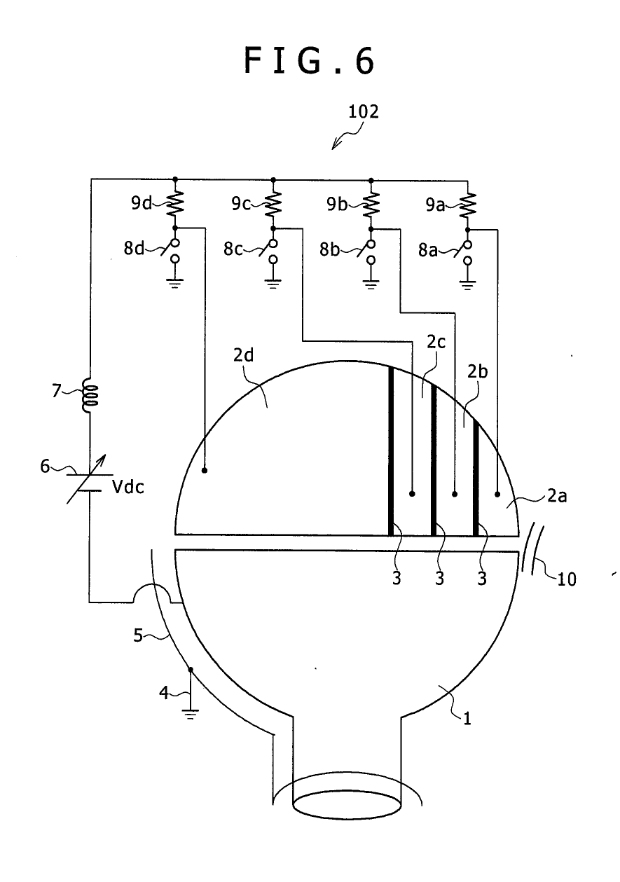

The circular accelerator of third embodiment of the present invention is described next while referring to FIG. 6. FIG. 6 is a concept drawing showing the overall structure of the vertical cross section of the circular accelerator 102 of the present embodiment.

The circular accelerator 102 of the present embodiment is a structure that applies a DC voltage Vdc from the DC power supply 6 between the dee electrode 1 and the dummy dee electrode 2, and in this way generates an E×B drift by way of electric field E and bend magnetic field B, to change the extracted beam energy and extract the charged particle beam the same as the circular accelerator 100 of the first embodiment. In the circular accelerator 100 of the first embodiment, the dummy dee electrode 2 is formed concentrically as multiple insulated and divided structure. However, in the circular accelerator 102 of the present embodiment, the dummy dee electrode 2 is arranged linearly in multiple insulated and divided structures. Comparing the circular accelerator 102 of the present embodiment with the circular accelerator 100 having dummy dee electrodes that are divided and insulated in a concentric state as in the first embodiment, shows that the circular accelerator 102 of the present embodiment has the insulated and divided dummy dee electrode structure in a linear shape so that the manufacturing cost can be reduced and changes can be made to the energy. In the circular accelerator 102 of the present embodiment, the DC electric field of the insulator sections for the divided dummy dee electrodes 2a, 2b, 2c, 2d is applied only in a fixed direction so that when drift occurs in the beam orbit of the charged particle beam due to the generation of E×B drift, the isochronism might be broken so that the case might occur where the particles are not capable of normally accelerating to the target energy. So installing additional equipment such as a trim coil might become necessary in order to compensate the isochronous magnetic field.

The circular accelerator 102 of the present embodiment is capable of changing the extraction beam energy, requires no degrader of the related art for changing the energy, and can therefore prevent deterioration in beam performance due to the emittance growth and so on generated accompanying the energy loss in the beam due to the degrader. Moreover, the overall accelerator system can be achieved in a compact size and a lower cost because no degrader is required.

The present embodiment is capable of changing and adjusting the energy of the extraction beam from the circular accelerator 102 by adjusting the DC voltage to the multiple insulated and divided electrodes to which a DC voltage is applied. No changes are made to the magnetic field and the acceleration frequency so that the overall circular accelerator system including an energy change device for the extraction beam is capable of high performance, a compact size, and a lower cost, and also capable of extracting the beam with high efficiency and minimal beam loss, which contributes to even higher performance.

### Fourth Embodiment

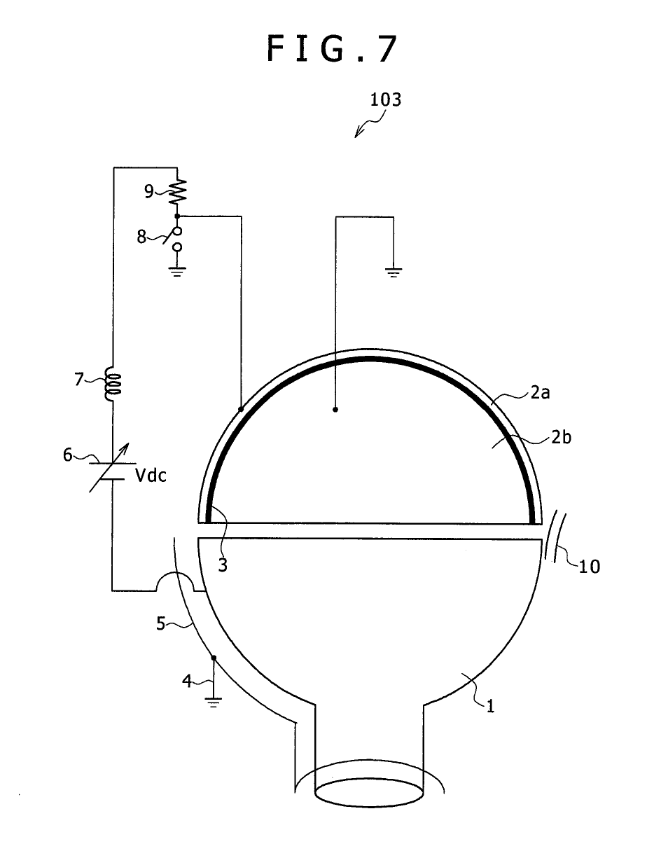

The circular accelerator of fourth embodiment of the present invention is described next while referring to FIG. 7. FIG. 7 is a concept drawing showing the overall structure of the vertical cross section of the circular accelerator 103 of the present embodiment.

The circular accelerator 103 of the present embodiment, the same as for the circular accelerator 100 of the first embodiment, is a structure in which a DC power supply 6 applies a DC voltage Vdc between a dee electrode 1 and a dummy dee electrode 2 that is insulated and divided in a concentric circle shape near the maximum radius of the orbit. An E×B drift is generated by the electric field E and bending magnetic field B from that applied DC voltage Vdc, expanding the gap between the last two turn orbits of the beam, and the beam conducts to the deflector electrode to reduce the amount of loss, and the beam is extracted with high efficiency. The point where the circular accelerator 103 of the present embodiment differs from the circular accelerator 100 of the first embodiment is that the objective is high-efficiency beam extraction rather than changing the extracted beam energy.

Generally, in circular accelerators for bending the orbit in a magnetic field B and accelerating particles in a high frequency electric field by way of an RF acceleration cavity, an E×B drift is generated by a DC electric field E and a bending magnetic field B, so that the above described first through the fourth embodiments can be applied in the same way as these extraction beam energy changing systems or high efficiency beam extracting methods, and can achieve high performance, compactness, and low cost in all systems including charged particle beam extraction and energy changing devices.

The circular accelerator 103 of the present embodiment is capable of changing the extraction beam energy, requires no degrader of the related art for changing the energy, and can therefore prevent degradation in beam performance due to the emittance growth and so on generated accompanying the energy loss in the beam due to the degrader. Moreover, the overall accelerator system can be achieved a compact size and a lower cost because no degrader is required.

The present embodiment is capable of changing and adjusting the energy of the extraction beam from the circular accelerator 103 by adjusting the DC voltage to the multiple insulated and divided dummy dee electrodes 2 to which a DC voltage is applied. No changes are made to the magnetic field and the acceleration frequency so that the overall circular accelerator system including an energy change device for the extraction beam is capable of high performance, a compact size, and a lower cost, and further capable of a high efficiency beam extraction with minimal beam loss, which contributes to even higher performance.

A charged particle beam was described in the first through the fourth embodiments however if a beam, even if of electrons or protons, then the energy varing method in the circular accelerator of the present invention can be achieved.

What is claimed is:

1. A circular accelerator comprising:
an electrode that applies an RF electric field to accelerate the charged particle beam;
a bending magnet that bends the charged particle beam; and
a DC power supply device that applies a DC electric field to the previous described electrode.

2. The circular accelerator according to claim 1,
wherein the electrode is divided into a plurality of electrodes, and each of divided electrodes is insulated by insulator material, and
wherein the circular accelerator further includes a switching device that applies a DC voltage from the DC power supply device to the electrode selected from the previous described plurality of electrodes.

3. The circular accelerator according to claim 1,
wherein the electrode includes a dee electrode and a dummy dee electrode that apply an RF electric field to accelerate the charged particle beam,
wherein the dummy dee electrode is divided into concentric circle shapes and insulated by insulator material,
wherein the circular accelerator further includes a switching device that applies a DC voltage from the DC power supply device to the previous described dummy dee electrode selected from the sub-divided dummy dee electrodes, and
wherein an E×B drift is generated by a magnetic field B and a DC electric field E along the beam orbit of the charged particle beam, the extracted beam energy is varied.

4. The circular accelerator according to claim 1,
wherein the electrode includes an insulation sub-divided structure near the maximum radius of the beam orbit of the charged particle beam,
wherein the circular accelerator further includes a switching device that applies a DC voltage from the DC power supply device to the previous described electrodes insulated near the maximum radius of the beam orbit of the charged particle beam, and
wherein an E×B drift is generated by the magnetic field B and DC electric field E near the maximum radius of the beam orbit, the gap is expanded between the last two turn orbits of the extracting particle beam.
